(19) United States
(12) Patent Application Publication
(10) Pub. No.: US 2026/0067615 A1
(43) Pub. Date: Mar. 5, 2026

(54) DIRECTIONAL SOUND APPARATUS AND METHOD

(71) Applicant: ZEROSOUND SYSTEMS INC., Calgary (CA)

(72) Inventors: Raymond SOBOL, Kelowna (CA); Norm W. BOGNER, Calgary (CA); Mark ALLEN, Foothills (CA); Chad SARTISON, Calgary (CA); Jeremy PARKER, Calgary (CA)

(21) Appl. No.: 19/105,922

(22) PCT Filed: Apr. 26, 2023
(86) PCT No.: PCT/CA2023/050565

§ 371 Date: Feb. 24, 2025

Related U.S. Application Data
(60) Provisional application No. 63/373,919, filed on Aug. 30, 2022.

(51) Int. Cl. H04R 1/40; G10K 11/178; H04R 3/12

(52) U.S. Cl. CPC H04R 1/403; G10K 11/17857; G10K 11/17881; H04R 3/12; G10K 2210/111; G10K 2210/1282; H04R 2499/13

(57) ABSTRACT

A directional speaker apparatus has a source speaker for emitting a source sound; and a suppression speaker for emitting a suppression sound. A method for directional sound emission includes emitting a source sound from a source speaker; and emitting a suppression sound from a suppression speaker.

### BENEFIT OF EARLIER APPLICATIONS

This application claims priority from US provisional application 63/373,919, filed Aug. 30, 2022.

### TECHNICAL FIELD

The present invention relates to sound reproduction in general, and directional sound apparatus and methods in particular.

### BACKGROUND

Speakers on the market today are generally built to emit sound with specific throw angles. Such speakers are generally intended to be as loud as possible throughout their throw angle range, with the unintended consequence of possible sound levels outside of the desired throw angle range.

### SUMMARY OF INVENTION

In accordance with a broad aspect of the present invention, there is provided a directional speaker apparatus, comprising: a source speaker for emitting a source sound; and a suppression speaker for emitting a suppression sound.

In accordance with another broad aspect of the present invention, there is provided a method for directional sound emission, comprising: emitting a source sound from a source speaker; and emitting a suppression sound from a suppression speaker.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1A is a front elevation view of a directional sound apparatus according to one embodiment of the present invention;

FIG. 1B is a plan view of the embodiment of FIG. 1A;

FIG. 1C is a side elevation view of the embodiment of FIG. 1A;

FIG. 1D is a perspective view of the embodiment of FIG. 1A;

FIG. 2A is a front elevation view of a directional sound apparatus according to another embodiment of the present invention;

FIG. 2B is a perspective view of the embodiment of FIG. 2A;

FIG. 2C is a side elevation view of the embodiment of FIG. 2A;

FIG. 3A is a front elevation view of a directional sound apparatus according to yet another embodiment of the present invention;

FIG. 3B is a perspective view of the embodiment of FIG. 3A;

FIG. 3C is a side elevation view of the embodiment of FIG. 3A;

FIG. 4A is a front elevation view of a directional sound apparatus according to yet another embodiment of the present invention;

FIG. 4B is a perspective view of the embodiment of FIG. 4A;

FIG. 4C is a side elevation view of the embodiment of FIG. 4A;

FIG. 5A is a front elevation view of a directional sound apparatus according to yet another embodiment of the present invention;

FIG. 5B is a perspective view of the embodiment of FIG. 5A; and

FIG. 5C is a side elevation view of the embodiment of FIG. 5A.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

There is a demand for speaker apparatus and methods capable of emitting sound within a particular throw angle, while reducing or eliminating perceived sound outside of the intended throw angle. A directional sound apparatus, and a directional sound emission method, are provided.

The directional sound apparatus may include two or more speakers. Each speaker may have a throw angle range. The directional sound apparatus may have one or more microphones. The microphones may be used to implement active noise cancellation.

For example, there may be a microphone positioned within the throw angle of one or more of the speakers. The microphone may receive sound signals, including from the speaker. In one embodiment, there may be one or more microphones each positioned within a throw angle of two or more of the speakers.

Each of the speakers may have the same construction, or they may have differing constructions. Any number of speaker constructions may be used. For example, the speaker may have a traditional conical speaker construction, e.g., comprising a magnet, a coiled wire, and a membrane configured with each other. Alternatively, a planar speaker may be used.

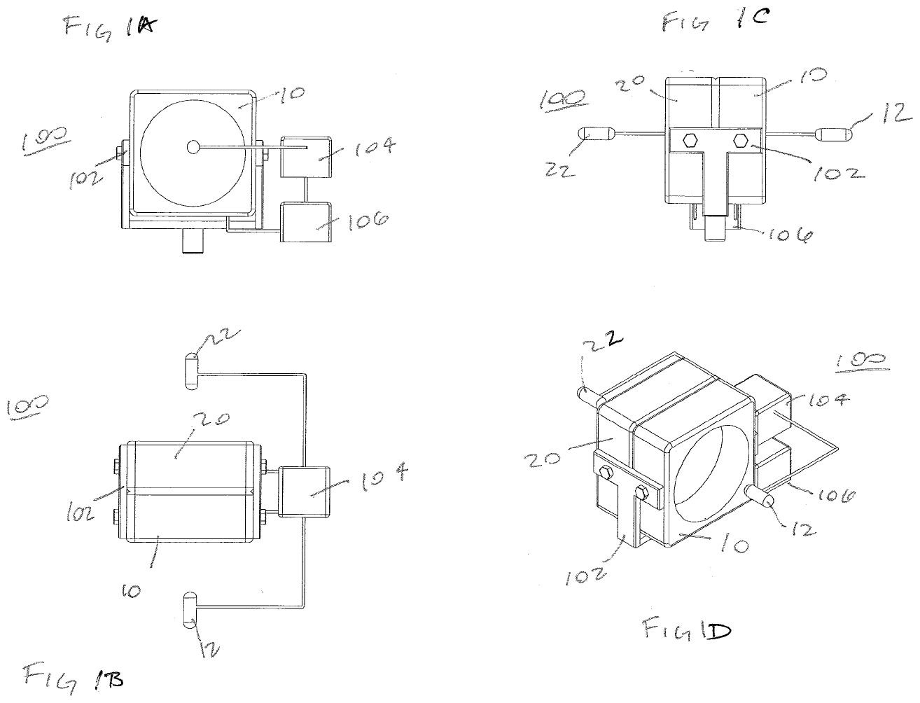

FIGS. 1A-1D illustrate a directional sound apparatus 100 according to one embodiment. The speakers shown are coupled together, e.g., via mounting bracket 102. Directional sound apparatus 100 includes a first speaker 10 (which may act as a source speaker), and a second speaker 20 (which may act as a suppression speaker). The speakers may be activated to emit sound. The build of each speaker may be any produced speaker technology available in the market now or in the future. The speakers may be of the same construction (i.e., substantially identical models), or different (i.e., different models or different speaker apparatus altogether).

Each speaker may be supplied audio via a signal, e.g., from a processor 104. In use, the source speaker is intended to play the desired sound, at a throw angle and magnitude, which may be selectable. The positioning of each speaker may be selected to achieve a desired sound profile, e.g., a desired throw angle and magnitude.

The suppression speaker is intended to play a calculated anti-phase and/or suppression sound to decrease the source speaker sound magnitude (and possibly that of any other undesired sounds) at a desired throw angle.

Each speaker may be couplable to a sound generation source, such as an amplifier 106, a computer, a mobile phone, or another device, to transmit a signal to the speaker. The speaker may receive the signal and emit a corresponding sound, i.e., sound waves.

The apparatus 100 may have an amplifier 106 to magnify the electrical output to the desired output level for each speaker. A single amplifier may correspond to a single speaker, or any number of speakers, e.g., all of the speakers of the apparatus. Alternatively, multiple amplifiers may be used, e.g., such that each speaker of the plurality of speakers is coupled to its own dedicated amplifier.

The source speaker sound may be provided from a source of the environment, such as a mobile phone equipped with audio output means.

The speakers may be assembled with any material such as plastic, metal, composites, etc. There is no specific requirement for what type of material is required for this invention to effectively work. Each speaker may include baffling, insulation, and outer housings to tune the emitted sound profiles to desired outputs.

A bracket 102 and/or a frame may hold the speakers in a desired position, e.g., back-to-back, as illustrated. The bracket may be part of and/or integral with the speaker frame. The bracket may also be part of an existing assembly or device that allows the speakers to be placed in the desired position. The bracket, baffling, insulation, and outer housings may be made of any materials specified to produce the desired sound profile from the system.

Certain speaker properties may be used to generate unique sounds for the sound profile. For example, a wired speaker could be matched with a wireless speaker, or a traditional speaker with a wide throw angle could be paired with a flat plate speaker with a small throw angle.

The speakers shown are coupled together, e.g., via mounting bracket 102. Directional sound apparatus 100 includes a first speaker 10 (which may act as a source speaker), and a second speaker 20 (which may act as a suppression speaker). The speakers may be activated to emit sound. The build of each speaker may be any produced speaker technology available in the market now or in the future. The speakers may be of the same construction (i.e., substantially identical models), or different (i.e., different models or different speaker apparatus altogether).

The speakers may be mounted in various orientations (e.g. back-to-front, back-to-back, one speaker vertical, one on its side, etc.) depending on desired sound profile, e.g., throw angle. The distance between the speakers in the assembled orientation may also vary based on the scenario or location of mounting, and the desired sound profile.

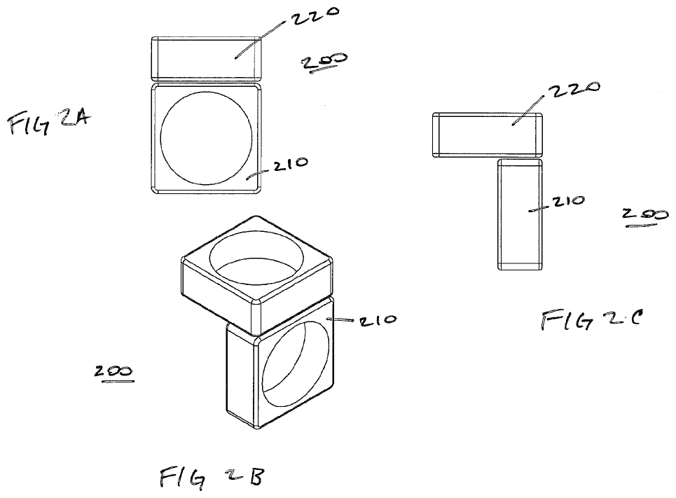

FIGS. 2A-2C illustrate a directional sound apparatus 200 according to one embodiment. The speakers are shown oriented such that they are facing in perpendicular directions. As shown in FIG. 2B, a first speaker 210 is facing out of the page toward the reader, and a second speaker 220 is facing up toward the top of the page. In other words, first speaker 210 is facing in a first direction, and a second speaker 220 is facing a direction that is substantially 90 degrees from the first direction.

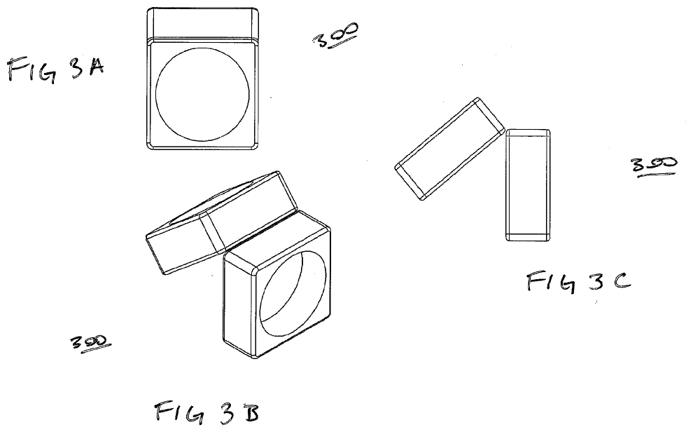

FIGS. 3A-3C illustrate a directional sound apparatus 300 according to one embodiment. As shown in FIG. 3B, a first speaker 310 is facing a first direction, and a second speaker 220 is facing a direction that is between 90 and 180 degrees from the first direction.

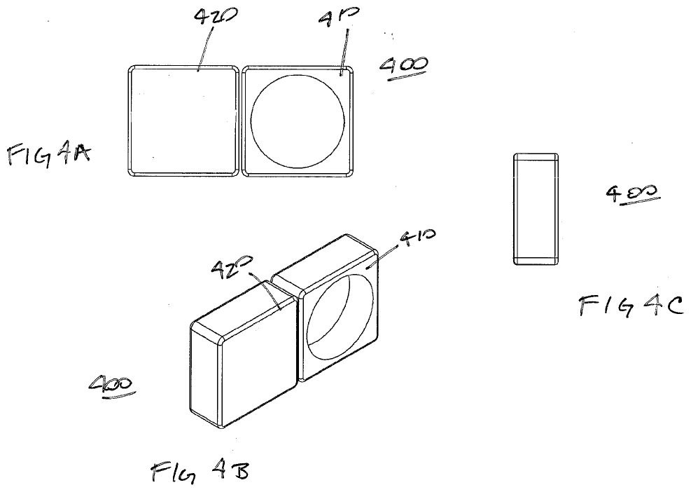

FIGS. 4A-4C illustrate a directional sound apparatus 400 according to one embodiment. As shown in FIG. 4B, a first speaker 410 is facing a first direction, and a second speaker 420 is facing a direction that is between 180 degrees from the first direction. Speakers 410 and 420 are disposed next to one another.

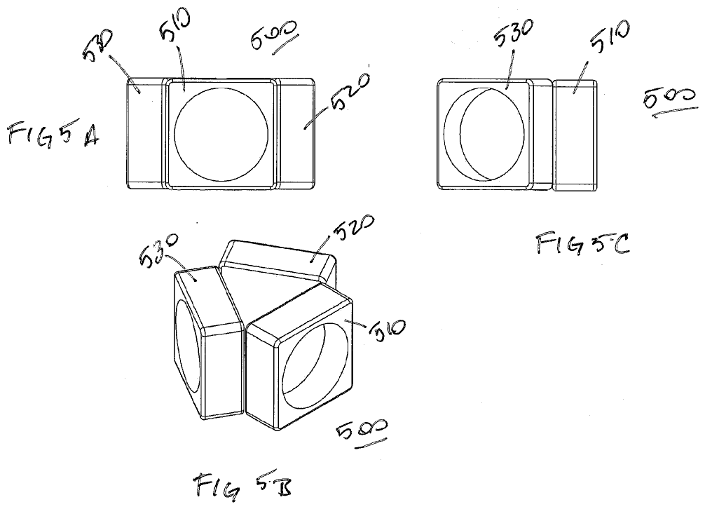

FIGS. 5A-5C illustrate a directional sound apparatus 500 according to one embodiment. As shown in FIG. 3A, a first speaker 510 is facing a first direction, a second speaker 520 is facing a second direction that is between 120 degrees from the first direction, and a third speaker 530 is facing a third direction that is 120 degrees from each of the first direction and the second direction. Speakers 510, 520, and 530 are disposed with their backs facing inward, such that each speaker faces outward. Speaker 510 may be a source speaker, and speakers 520, 530 may be suppression speakers.

The speaker apparatus may include multiple wires and coils on the same membrane, which may allow for a larger speaker apparatus and/or improved sound quality and/or volume of sound emission. Multiple signals may be delivered to the same membrane via multiple wire coils. In one embodiment, each wire coil may be configured to emit different ranges of frequencies, which ranges may overlap. For example, a first wire coil may be configured to emit mid- and/or high-range frequencies, and a second wire coil may be configured to emit low-range frequencies. The apparatus may emit sound on one or both sides of the membrane.

The system may include a processor 104 (e.g., a computer). In one embodiment, the processor may perform active noise cancellation algorithms or methods. The processor may listen to the source speaker, e.g., via a source microphone 12, calculate a suppression soundwave, and send the suppression soundwave to the suppression speaker 20. For example, the processor may perform active noise cancellation calculations based on data from the source speaker in real time to suppress sound in a desired path, e.g., throw angle of the suppression speaker. The processor may be coupled to computer readable memory having recorded thereon statements and instructions for execution by the processor for calculating a suppression sound to reduce the perceived source sound at a desired location within the throw angle of the suppression speaker.

In one embodiment, output sounds of the source speaker may be known, for example, if the source speaker is configured to act as a siren. In such circumstances, the suppression sounds, and suppression speaker output sounds, can be predetermined. The known suppression output can be played by the suppression speaker without the need for a processor or microphone, or with such components disabled. There may be applications that combine a predetermined suppression method/apparatus along with the use of an active noise cancellation method/apparatus to achieve the desired sound profile.

In one embodiment, a source microphone 12 may be disposed proximate (e.g., in front of) the source speaker. The source microphone may listen to the source sound to supply the processor with information for calculating suppression sounds.

Optionally, a suppression microphone 22 may be disposed proximate (e.g., in front of) the suppression speaker. The suppression microphone may be used to supply the processor with information of how a targeted suppression is performing, which may be used by the processor to tune the suppression speaker and/or the source speaker. Microphones also may provide feedback to the processor for optimizing suppression sounds further. Further, or in the alternative, a microphone may be disposed proximate where noise suppression is desired, to collect data regarding sounds detectable at that location, and to provide feedback to the processor to adjust the output of one or more of the speakers such that noise suppression may be implemented.

A first distance between the source microphone and the source speaker may be different (e.g., lesser than) a second distance defined between the suppression microphone and the suppression speaker. The suppression microphone may be positioned at a location where noise suppression is desired, and/or further (e.g., another suppression microphone) may be positioned at additional locations where noise suppression is desired, and the processor may receive data from each of the microphones to process a suppression sound optimized to suppress noise at each of the locations. For example, in an ambulance application of a dual speaker apparatus, the source speaker may emit a siren sound, the suppression microphone may be positioned proximate the driver's seat, and the second suppression microphone may be positioned proximate the patient's cot, such that the suppression microphones can provide data to the processor to instruct the second speaker to emit a suppression sound to reduce noise for both the driver and the patient.

In another embodiment involving application of the instant technology to an ambulance, the source speaker may face forwards to emit sound toward the front of the ambulance, and the suppression speaker face rearwards to suppress the siren sound toward the rear of the ambulance. In such an embodiment, traffic in front of the ambulance would hear the siren, and those behind the ambulance would hear reduced siren noise, or possibly no siren noise at all.

It is to be understood that while an application of the instant technology in an ambulance is described, the invention could be used in any siren-equipped vehicle (e.g., police or fire department vehicles) in a similar manner.

Microphones used may vary on application and may be selected, for example, to optimally capture the sound types and levels produced. Microphones may be wired and/or wireless variations. Further or alternatively, the sound information can be acquired without the use of microphones by capturing the electrical data with transducers, accelerometers, or other apparatus.

The sound information captured via microphones or other data capture techniques may also be stored and transmitted as performance and/or analytics data to a remote and/or onboard computer. This data may be provided in real-time, and/or periodically, and may be sorted e.g., by a particular time period, location, and/or other parameters.

Reference is made to international patent application PCT/CA2019/050597 entitled “Apparatus and Method for Active Noise Reduction” and other members of this patent family (“‘597”). It is to be appreciated that the present apparatus may be adapted for active noise reduction by:
(a) sensing one or more characteristics of a sound wave;
(b) calculating an inverted sound wave based on the one or more characteristics; and
(c) emitting the inverted sound wave by flowing a current, selected according to the inverted sound wave, through a conductor magnet apparatus, thereby producing sound.

Sensing may include sensing at a plurality of locations. The plurality of locations may include a first location and a second location, and calculating may further include computing a speed of sound between the first location and the second location based on a distance between the first location and the second location, and the one or more characteristics detected over a period of time at each of the first location and the second location. The one or more characteristics includes one or more of a frequency and an amplitude. The apparatus may include one or more of:
(a) a microphone configured to detect one or more characteristics of a sound wave detected in a vicinity of the microphone;
(b) a processor coupled to the microphone, configured to calculate an inverted sound wave based on the one or more characteristics; and
(c) the apparatus may emit the inverted sound wave so as actively to reduce the noise of the sound wave.

In one embodiment, the speaker may idly listen and initiate noise cancellation when a certain threshold of noise, for example measured in decibels, is reached. The threshold may be predetermined, or may be selectable.

It is to be appreciated that the source speaker and suppression speaker may reverse roles, such that the direction of source sound and sound suppression are reversed. This may be controlled via the processor.

### Clauses

Clause 1. A directional speaker apparatus, comprising: a source speaker for emitting a source sound; and a suppression speaker for emitting a suppression sound.

Clause 2. The apparatus of any one or more of clauses 1-11, further comprising: a processor configured to calculate the suppression sound and send the suppression sound to the suppression speaker.

Clause 3. The apparatus of any one or more of clauses 1-11, further comprising a source microphone coupled to the processor.

Clause 4. The apparatus of any one or more of clauses 1-11, wherein the source microphone is disposed within a throw angle of the source speaker.

Clause 5. The apparatus of any one or more of clauses 1-11, further comprising a suppression microphone coupled to the processor.

Clause 6. The apparatus of any one or more of clauses 1-11, wherein the suppression microphone is disposed within a throw angle of the suppression speaker.

Clause 7. The apparatus of any one or more of clauses 1-11, wherein the source speaker is a siren and the source sound is a siren sound.

Clause 8. A method for directional sound emission, comprising: emitting a source sound from a source speaker; and emitting a suppression sound from a suppression speaker.

Clause 9. The method of any one or more of clauses 1-11, further comprising: calculating the suppression sound using a processor, and sending, via the processor, the suppression sound to the suppression speaker for emission.

Clause 10. The method of any one or more of clauses 1-11, further comprising: detecting sound characteristic data using a microphone, sending the sound characteristic data to the processor, and wherein calculating includes based on the sound characteristic data.

Clause 11. The method of any one or more of clauses 1-11, further comprising: positioning the source speaker to emit the source sound in a first desired throw angle; and orienting the suppression speaker to emit the suppression sound in a second desired throw angle.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element or step. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A directional speaker apparatus, comprising:
a source speaker for emitting a source sound; and
a suppression speaker for emitting a suppression sound.

2. The apparatus of claim 1, further comprising:
a processor configured to calculate the suppression sound and send the suppression sound to the suppression speaker.

3. The apparatus of claim 2, further comprising a source microphone coupled to the processor.

4. The apparatus of claim 3, wherein the source microphone is disposed within a throw angle of the source speaker.

5. The apparatus of claim 2, further comprising a suppression microphone coupled to the processor.

6. The apparatus of claim 5, wherein the suppression microphone is disposed within a throw angle of the suppression speaker.

7. The apparatus of claim 1, wherein the source speaker is a siren and the source sound is a siren sound.

8. A method for directional sound emission, comprising:
emitting a source sound from a source speaker; and
emitting a suppression sound from a suppression speaker.

9. The method of claim 8, further comprising:
calculating the suppression sound using a processor, and sending, via the processor, the suppression sound to the suppression speaker for emission.

10. The method of claim 8, further comprising:
detecting sound characteristic data using a microphone, sending the sound characteristic data to the processor, and wherein calculating includes based on the sound characteristic data.

11. The method of claim 8, further comprising:
positioning the source speaker to emit the source sound in a first desired throw angle; and
orienting the suppression speaker to emit the suppression sound in a second desired throw angle.
